(19) United States
(12) Patent Application Publication
(10) Pub. No.: US 2005/0060391 A1
(43) Pub. Date: Mar. 17, 2005

(54) Autonomic cluster-based optimization

(75) Inventors: David Louis Kaminsky, Chapel Hill, NC (US); John Michael Lake, Cary, NC (US); David M. Ogle, Cary, NC (US)

Correspondence Address: CHRISTOPHER & WEISBERG, PA, 200 E. LAS OLAS BLVD, SUITE 2040, FT LAUDERDALE, FL, 33301, US

(73) Assignee: International Business Machines Corporation, Armonk, NY (US)

(21) Appl. No.: 10/663,125

(22) Filed: Sep. 16, 2003

(51) Int. Cl. G06F 15/173

(52) U.S. Cl. 709/220

(57) ABSTRACT

A system for autonomically configuring a cluster of nodes can include a knowledge base of workload descriptions and associated configuration parameters, a genetic computing processor programmed to produce a selection of configuration parameters for a particular workload based upon a set of existing configuration parameters in the knowledge base, and, a controller coupled to the knowledge base and the cluster of nodes. The controller can include programming for monitoring the cluster of nodes and for applying individual ones of the selection of configuration parameters to the cluster of nodes to achieve an improved state of operation.

### BACKGROUND OF THE INVENTION

1. Statement of the Technical Field

The present invention relates to the field of autonomic computing and more particularly to the autonomic optimization of cluster configuration.

2. Description of the Related Art

Autonomic computing represents the principal challenge of computer science today. In the famed manifesto, Autonomic Computing: IBM's Perspective on the State of Information Technology, Paul Horn, Senior Vice President of IBM Research, observed, “It's not about keeping pace with Moore's Law, but rather dealing with the consequences of its decades-long reign.” Given this observation, Horn suggested a computing parallel to the autonomic nervous system of the biological sciences. Namely, whereas the autonomic nervous system of a human being monitors, regulates, repairs and responds to changing conditions without any conscious effort on the part of the human being, in an autonomic computing system, the system must self-regulate, self-repair and respond to changing conditions, without requiring any conscious effort on the part of the computing system operator.

Thus, while the autonomic nervous system can relieve the human being from the burden of coping with complexity, so too can an autonomic computing system. Rather, the computing system itself can bear the responsibility of coping with its own complexity. The crux of the IBM manifesto relates to eight principal characteristics of an autonomic computing system:
I. The system must “know itself” and include those system components which also possess a system identify.
II. The system must be able to configure and reconfigure itself under varying and unpredictable conditions.
III. The system must never settle for the status quo and the system must always look for ways to optimize its workings.
IV. The system must be self-healing and capable of recovering from routine and extraordinary events that might cause some of its parts to malfunction.
V. The system must be an expert in self-protection.
VI. The system must know its environment and the context surrounding its activity, and act accordingly.
VII. The system must adhere to open standards.
VIII. The system must anticipate the optimized resources needed while keeping its complexity hidden from the user.

Though developed independently from the notion of autonomic computing, genetic programming addresses the challenge of autonomic computing by providing a method for automatically creating a working computer program from a high-level problem statement of the problem. Genetic programming achieves the goal of automatic programming (also sometimes called program synthesis or program induction) by genetically breeding a population of computer programs using the principles of Darwinian natural selection and biologically inspired operations. The general operations attributable to genetic programming include reproduction, crossover (sexual recombination), mutation, and architecture-altering operations patterned after gene duplication and gene deletion in nature.

The Standard Genetic Algorithm represents a concrete implementation of the generalized notion of genetic programming in which the model of haploid sexual reproduction has been applied to the creation of successive generations of electronic information. In the Standard Genetic Algorithm, the population subject to transformation includes a set of electronic information. Each individual element in the set can represent the analog to the chromosome of a life form. In this regard, two or more individual elements can be selected to engage in a reproductive cycle. During this cycle, the selected elements can crossover and split again forming additional new elements. Next, the additional new elements subsequently can mutate and the process can repeat until a new generation of electronic data as been produced.

Algorithmically, the Standard Genetic Algorithm includes seven well-known method steps:

1. Start with a population of n random individuals each with I-bit chromosomes.

2. Calculate the fitness f(x) of each individual in the population.

3. Choose, based upon “fitness”, two individuals and re-label the chosen individuals as “parents”. Remove the parents from the population.

4. Use a random process to determine whether to perform crossover. If so, refer to the output of the crossover as the “children”. If not, simply refer to the parents as the children.

5. Mutate the children with a probability of mutation for each bit.

6. Place the children into an empty set referred to as the “new generation”.

7. Return to Step 2 until the new generation contains n individuals. Delete one child at random if n is odd. Then replace the old population with the new generation. Return to Step 1.

Notably, the Standard Genetic Algorithm and genetic programming in general has been applied to a number of problems in the field of computer science. For instance, Mark Folker of De Montfort University in the United Kingdom has applied genetic programming concepts to the prediction of certain aspects of computer system performance. By comparison, Henrik Borgvall at Chalmers University of Technology, Institute of Theoretical Physics, in Gothenburg, Sweden has applied genetic programming concepts to the induction of Java byte code. As yet a further comparison, Eduard Lukschandl of Ericsson Hewlett-Packard Telecom has applied genetic programming concepts to routing problems within telecommunications networks.

Nevertheless, heretofore there has been no application of genetic programming concepts to the optimal configuration of network components—particularly within computing clusters. As it will be recognized by the skilled artisan, computing clusters have become common in the field of high-availability and high-performance computing. Cluster-based systems exhibit three important and fundamental characteristics or properties: reliability, availability and serviceability. Each of these features are of paramount importance when designing the software and the hardware of a new robust clustered system.

As opposed to the symmetric multi-processing (SMP) systems whose scalability can be limited and which can result in substantially diminished returns upon the addition of processors to the system, a clustered-based system consists of multiple computers that are connected over high-speed network communicative linkages. Each computer in the cluster enjoys its own memory, possibly its own disk space and it hosts its own local operating system. Each node within the cluster system can be viewed as a processor-memory module that cooperates with other nodes such that it can provide system resources and services to user applications.

Clusters can be characterized by increased availability since the failure of a particular node does not affect the operation of the remaining nodes. Rather, any one failed node can be isolated and no longer utilized by the cluster-based system until the node can be repaired and incorporated again within the cluster. Additionally, the load of a failed node within a cluster can be equitably shared among the functional nodes of the cluster. Thus, clusters have proven to be a sensible architecture for deploying applications in the distributed environment and clusters are now the platform of choice in scalable, high-performance computing.

In the prototypical cluster environment, each node in the cluster can be configured identically to improve manageability. Selecting a particular configuration for the cluster, however, can prove challenging as it can be difficult to know whether the entire cluster operates in an optimal state. Nevertheless, a principal tenet of autonomic computing requires that autonomic systems constantly seek a better operating state. Presently, though, cluster based systems do not constantly seek a better operating state through re-configuration.

### SUMMARY OF THE INVENTION

The present invention addresses the deficiencies of the art in respect to the optimization of a cluster of nodes and provides a novel and non-obvious method, system and apparatus for autonomically optimizing the configuration of nodes within a cluster using genetic programming technology. A system for autonomically configuring a cluster of nodes can include a knowledge base of workload descriptions and associated configuration parameters, a genetic computing processor programmed to produce a selection of configuration parameters for a particular workload based upon a set of existing configuration parameters in the knowledge base, and, a controller coupled to the knowledge base and the cluster of nodes. The controller can include programming for monitoring the cluster of nodes and for applying individual ones of the selection of configuration parameters to the cluster of nodes to achieve an improved state of operation.

Notably, the knowledge base can include in addition to the configuration parameters and workload descriptions, performance measures associated with the workload descriptions. The knowledge base also can include a listing of acceptable configuration parameters which when applied achieve a level of performance which exceeds pre-defined baseline objectives. Conversely, the knowledge base can include a listing of unacceptable configuration parameters which when applied fail to achieve a level of performance which exceeds pre-defined baseline objectives. Finally, the knowledge base can be configured for coupling to one or more controllers which are further coupled to one or more corresponding clusters of nodes.

A method for autonomically optimizing a cluster of nodes can include detecting a node in the cluster which requires re-configuration. A workload hosted by the node can be identified and a set of configuration parameters associated with the workload can be retrieved. A new generation of configuration parameters can be produced based upon the retrieved set using a genetic computing process. Finally, the node can be reconfigured with selected ones of the new generation of configuration parameters. Importantly, the detecting step can include detecting at least one condition selected from the group consisting of a node crash, node idleness, node underperformance, and a change in workload hosted in the node.

In accordance with the present invention, a genetic computing process can be applied to a set of configuration parameters to produce a new generation of configuration parameters from which a new configuration can be selected for application to the node. In this regard, the producing step can include performing a crossover operation for the configuration parameters in the retrieved set. Additionally, at least one element of the configuration parameters in the retrieved set can be mutated to produce a new generation of configuration parameters. Finally, a new configuration can be randomly selected from among the new generation of configuration parameters. Based upon the random selection, it can be determined whether the randomly selected new configuration is viable. In this regard, the node can be reconfigured with the randomly selected new configuration only if the new configuration is determined to be viable.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is schematic illustration of a cluster of nodes which has been configured with the autonomic optimization system of the present invention;

FIG. 2 is a flow chart illustrating a process for autonomically optimizing individual nodes in a cluster; and,

FIG. 3 is a schematic illustration of a set of clusters which have been configured with a global implementation of the autonomic optimization system of the present invention.

### DETAILED DESCRIPTION OF THE PREFERRED EMBODIMENTS

The present invention is an autonomic cluster-based optimization system, method and apparatus. In accordance with the inventive arrangements, a genetic computing process can be combined with a knowledge base of configuration parameters, workload descriptions and performance observations to provide on-line, real-time adaptability to changing workloads. The genetic computing process can produce generations of different configurations for individual nodes in the cluster. Selected ones of the configurations in the generation can be tested experimentally to identify a better operating state for the cluster. Thus, the present invention adheres to the autonomic tenet that a system ought to constantly search for a better operating state. The use of a knowledge base, by comparison, can ensure that the adaptation to a better operating state can be quick and effective, and that the system conducts increasingly focused experiments over time to identify better operating states.

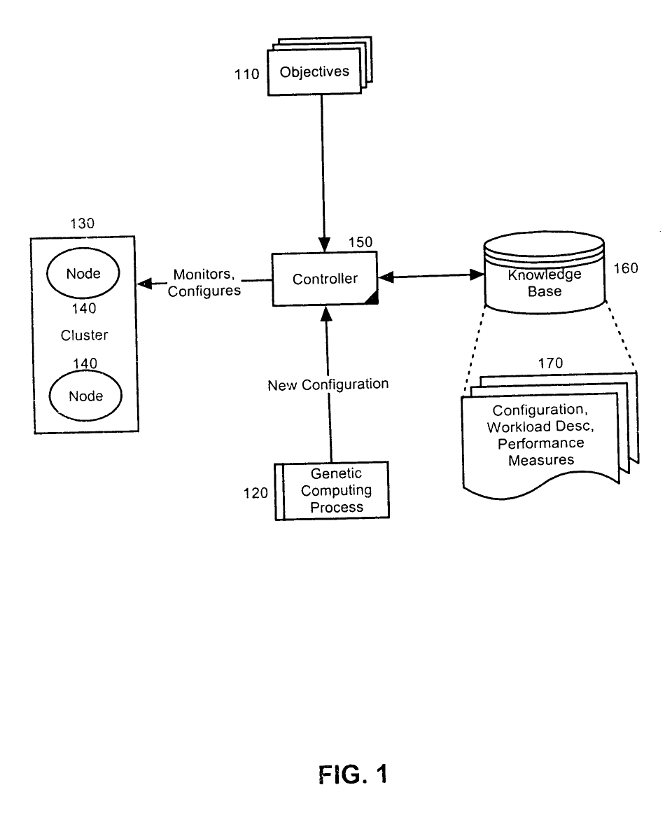

FIG. 1 is schematic illustration of a cluster of nodes which has been configured with the autonomic optimization system of the present invention. The autonomic optimization system can include a controller 150 coupled both to a knowledge base 160 and a cluster 130 of nodes 140 (only two nodes shown form the purpose of simplicity of illustration). The controller 150 is a monitoring system which can monitor the operation of the nodes 140 within the cluster 130. In particular, the controller 150 can detect when a node 140 is operational, the performance characteristics of the operational node 140, when the node 140 “crashes”, and when the node is idle. Notably, by monitoring the performance characteristics of a node 140, the controller 150 further can detect significant changes in the workload handled by the node 140.

The knowledge base 160, by comparison, can include relationships 170 between configuration parameters, workload descriptions and performance measures. As part of these relationships 170, the knowledge base 160 can store granular data including individual workload descriptions for the nodes 140 and individual performance measures for the nodes 140. Importantly, the knowledge base 160 also can store a set of configuration parameters, both preferred and avoided. In this regard, the knowledge base 160 can include a listing of active configurations, historically utilized configurations, and yet unused configurations. Associated with each configuration, data can be stored which can indicate the actual performance of a node 140 in respect to the particular configuration and whether the configuration is to be preferred or avoided.

Aside from the cluster 130 and the knowledge base 160, the controller 150 further can be coupled to a genetic computing process 120. The genetic computing process 120 can perform a genetic algorithm for producing new generations of configuration parameters from existing generations of configuration parameters. Several known genetic computational algorithms can be implemented within the genetic computing process, including those genetic algorithms which are consistent with the Standard Genetic Algorithm known in the art. The controller 150 can access individual configuration parameters within a produced new generation of configuration parameters in order to experimentally seek a better operating state for the cluster 130.

Finally, the controller 150 can be yet further coupled to a set of objectives 110. The set of objectives can include baseline objectives for the performance of the cluster 130 and the nodes 140 within the cluster 130. Exemplary baseline objectives can include, for instance, “The application response time shall be no longer than Y milliseconds over an X-second interval.” Experimentally, where a node 140 fails to meet any one of the objectives 110, the configuration thereof can be marked as disfavored and a different configuration can be applied. Experiments which meet the minimum required operational objectives can be added to the knowledge base 10 to form the guidance for future experiments and configuration changes. Thus, by combining the objectives 110 and by experimentally ensuring that different applied configurations of the nodes 140 within the cluster 130 achieve these objectives 110, the objective function of the cluster 130 can be optimized by the combined actions of the genetic computing process 120 and the knowledge base 160.

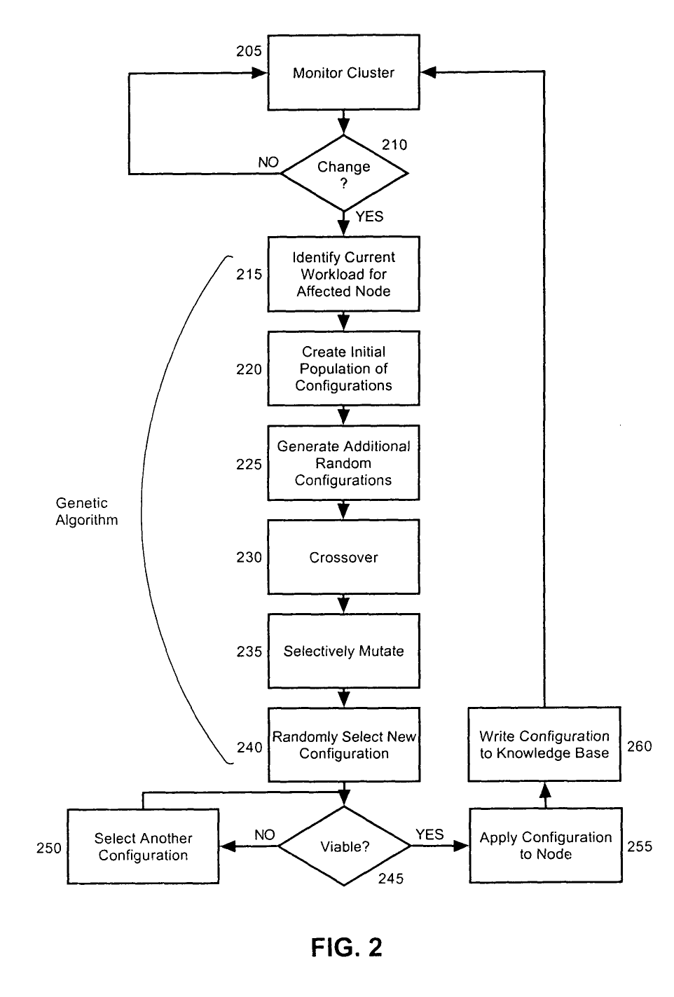

FIG. 2 is a flow chart illustrating a process for autonomically optimizing individual nodes in a cluster. Beginning in block 205, the cluster of nodes can be monitored to identify when a change in configuration is appropriate. Changes in configuration can be appropriate when performance objectives are not met, when a node fails, when a node has become idle, when the workload has significantly changed, when a certain amount of time has passed, or upon the occurrence of any other suitable criteria. In decision block 210, if a change in configuration is not appropriate, the process can return to block 205 and the cluster can continue to be monitored. Otherwise, the process can continue through block 215.

When it is determined that a configuration change is appropriate, in block 215 the current workload can be identified for the affected node. In block 220, an initial population of possible configurations can be generated based upon the identified workload. More specifically, within the knowledge base, a set of records can be included in which a configuration, workload description and performance measures can be associated with one another. Hence, to retrieve an initial set of possible configurations can include scanning the knowledge base for associated configurations based upon the identified workload.

In any case, in addition to retrieving known possible configurations from the knowledge base, in block 225 additional configurations can be generated randomly. In block 230, a crossover operation can be applied to the configurations as is known in the art of genetic programming to produce a set of child configurations. Moreover, in block 235, a semantically driven selective mutation can be applied to the set of child configurations to produce a new generation of possible configurations. Finally, in block 240, a new configuration can be selected from among the new generation of possible configurations.

In decision block 245, it can be determined whether the randomly selected new configuration is semantically coherent and thus viable. If not, in block 250, yet another configuration can be randomly selected from among the new generation of possible configurations and, again, in decision block 245 it can be determined whether the randomly selected new configuration is viable. This process of blocks 245 and 250 can repeat until a configuration is determined viable. In that case, in block 255 the viable configuration can be applied to the affected node and in block 260 the configuration can be written to the knowledge base.

Importantly, while the process of FIG. 2 relates specifically to the configuration of a single node in a cluster, it will be recognized by the skilled artisan that such limitation is shown solely for the purpose of simplicity of illustration. In fact, it should further be recognized by one skilled in the art that the process of FIG. 2 can be extended to all or a portion of the nodes within a cluster, and again across multiple clusters. Additionally, the knowledge base of the present invention need not be limited to a coupling strictly to a single controller monitoring a single cluster. Rather, the knowledge base can be globalized and coupled to multiple controllers monitoring respective multiple clusters so that the range and meaning of the configurations stored in the knowledge base can be leveraged for the entire enterprise.

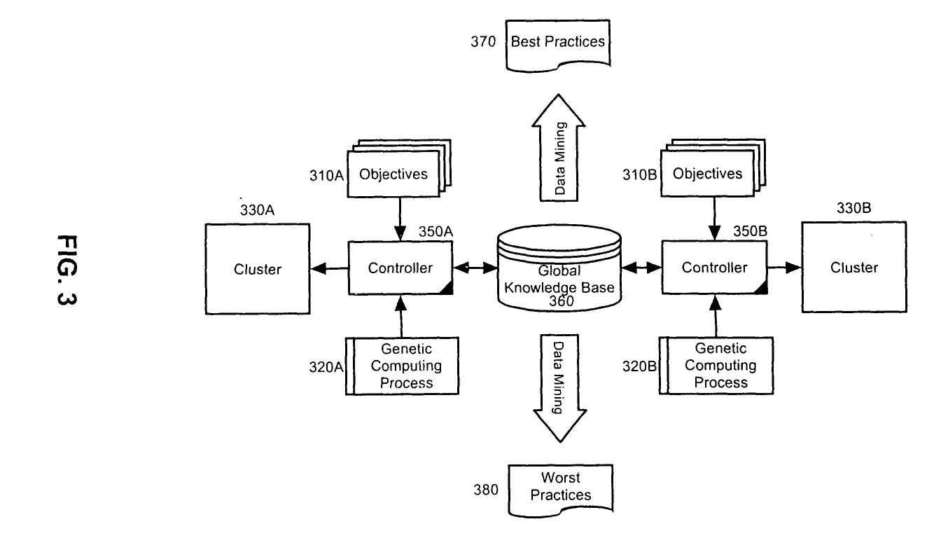

In this regard, FIG. 3 is a schematic illustration of a set of clusters which have been configured with a global implementation of the autonomic optimization system of the present invention. As it will be apparent from an inspection of FIG. 3, multiple clusters 330A, 330B (only two shown for simplicity of illustration) can be monitored by respective controllers 350A, 350B. Each controller can be coupled to respective genetic computing processes 320A, 320B though the invention is not limited in this regard. Rather, a single, shared genetic computing process (not shown) can form the basis of the process for creating new generations of configuration parameters, or separate genetic computing processes, each implementing the same or a different genetic algorithm can be coupled to their respective controllers 350A, 350B.

In any case, based upon the objectives 310A, 310B of each cluster, different configuration parameters can be applied to nodes within each cluster 330A, 330B to achieve a more optimal state. As certain combinations of parameter configurations are discovered experimentally to be optimal and preferred or disfavored, the configurations can be written to the global knowledge base 360 as such. In this way, the global knowledge base 360 itself can be mined to produce not only a listing of best practices 370 for the configuration of the nodes in the clusters 330A, 330B, but also a listing of worst practices 380 for the configuration of the nodes in the clusters 330A, 330B.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A system for autonomically configuring a cluster of nodes, the system comprising:
a knowledge base of workload descriptions and associated configuration parameters;
a genetic computing processor programmed to produce a selection of configuration parameters for a particular workload based upon a set of existing configuration parameters in said knowledge base; and,
a controller coupled to said knowledge base and the cluster of nodes, said controller comprising programming for monitoring the cluster of nodes and for applying individual ones of said selection of configuration parameters to the cluster of nodes to achieve an improved state of operation.

2. The system of claim 1, wherein said knowledge base further comprises performance measures associated with said workload descriptions.

3. The system of claim 1, wherein said knowledge base further comprises a listing of acceptable configuration parameters which when applied achieve a level of performance which exceeds pre-defined baseline objectives.

4. The system of claim 1, wherein said knowledge base further comprises a listing of unacceptable configuration parameters which when applied fail to achieve a level of performance which exceeds pre-defined baseline objectives.

5. The system of claim 1, wherein said knowledge base is configured for coupling to a plurality of controllers which are further coupled to a plurality of corresponding clusters of nodes.

6. A method for autonomically optimizing a cluster of nodes, the method comprising the steps of:
detecting a node in the cluster which requires re-configuration;
identifying a workload hosted by said node and retrieving a set of configuration parameters associated with said workload;
producing a new generation of configuration parameters based upon said retrieved set using a genetic computing process; and,
reconfiguring said node with selected ones of said new generation of configuration parameters.

7. The method of claim 6, wherein said detecting step comprises the step of detecting at least one condition selected from the group consisting of a node crash, node idleness, node underperformance, and a change in workload hosted in said node.

8. The method of claim 6, wherein said producing step comprises the steps of:
performing a crossover operation for said configuration parameters in said retrieved set; and,
mutating at least one element of said configuration parameters in said retrieved set to produce a new generation of configuration parameters.

9. The method of claim 8, wherein said reconfiguring step comprises the steps of:
randomly selecting a new configuration from among said new generation of configuration parameters;
determining whether said randomly selected new configuration is viable; and,
reconfiguring said node with said randomly selected new configuration only if said new configuration is determined to be viable.

10. The method of claim 9, further comprising the step of writing said randomly selected new configuration to a knowledge base if said randomly selected new configuration is determined to be viable.

11. The method of claim 9, further comprising the steps of:
measuring node performance for said reconfigured node; and,
if said reconfigured node fails to meet baseline objectives for performance for said reconfigured node, selecting a new configuration for said node and performing said determining and reconfiguring steps for said selected new configuration.

12. A machine readable storage having stored thereon a computer program for autonomically optimizing a cluster of nodes, the computer program comprising a routine set of instructions for causing the machine to perform the steps of:
detecting a node in the cluster which requires re-configuration;
identifying a workload hosted by said node and retrieving a set of configuration parameters associated with said workload;
producing a new generation of configuration parameters based upon said retrieved set using a genetic computing process; and,
reconfiguring said node with selected ones of said new generation of configuration parameters.

13. The machine readable storage of claim 12, wherein said detecting step comprises the step of detecting at least one condition selected from the group consisting of a node crash, node idleness, node underperformance, and a change in workload hosted in said node.

14. The machine readable storage of claim 12, wherein said producing step comprises the steps of:
performing a crossover operation for said configuration parameters in said retrieved set; and,
mutating at least one element of said configuration parameters in said retrieved set to produce a new generation of configuration parameters.

15. The machine readable storage of claim 14, wherein said reconfiguring step comprises the steps of:
randomly selecting a new configuration from among said new generation of configuration parameters;
determining whether said randomly selected new configuration is viable; and,
reconfiguring said node with said randomly selected new configuration only if said new configuration is determined to be viable.

16. The machine readable storage of claim 15, further comprising the step of writing said randomly selected new configuration to a knowledge base if said randomly selected new configuration is determined to be viable.

17. The machine readable storage of claim 15, further comprising the steps of:
measuring node performance for said reconfigured node; and,
if said reconfigured node fails to meet baseline objectives for performance for said reconfigured node, selecting a new configuration for said node and performing said determining and reconfiguring steps for said selected new configuration.
